(19) United States
(12) Patent Application Publication
(10) Pub. No.: US 2004/0047719 A1
(43) Pub. Date: Mar. 11, 2004

(54) Grappling attachment for skid steer loaders

(76) Inventor: Robert J. Helms, Edwardsville, IL (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/235,280

(22) Filed: Sep. 5, 2002

(51) Int. Cl. B66C 1/00

(52) U.S. Cl. 414/739

(57) ABSTRACT

A grappling attachment which can be attached to a skid steer loader. A skid steer loader is a common construction vehicle which is small in size and which can be configured to connect to a number of attachments. The grappling attachment attaches to the front end of the skid steer loader and provides the skid steer loader with the capability of reach forward to grab an object to be lifted, grasping the object with grappling fingers, lifting the object, transporting the object with the skid steer loader, and then placing the object at a new location. The grappling attachment includes connection points for quickly attaching the grappling attachment to the skid steer loader.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

This invention relates in general to a grappling attachment and, more particularly, to a grappling attachment for use with a skid steer loader.

2. Description of Related Art

The skid steer loader has become a ubiquitous piece of construction equipment which is used in almost every type of construction ranging from residential construction to large construction projects and highway construction. As such, the skid steer loader has become a mainstay within the construction industry.

The general concept and design of skid steer loaders has been the subject matter of a number of United States Patents. Perhaps the best example of skid steer loader patents is U.S. Pat. No. 4,055,262 which fully describes a common skid steer loader.

With the widespread use of the skid steer loader, there have also been a number of related products which have been invented and developed for use in conjunction with the skid steer loader. U.S. Pat. No. 5,413,181 discloses a rake attachment which attaches to the front of a common skid steer loader and which is used for lawn preparation activities such as grading, filling, leveling, and scarifying. U.S. Pat. No. 5,529,131 discloses a grading attachment which is secured to the front of the skid steer loader and which is used for leveling and moving earth. U.S. Pat. No. 5,081,941 claims an invention for an apparatus which can be used for excavating and transplanting trees or shrubbery. U.S. Pat. No. 5,234,282 discloses a gravity drop hammer which is again attached to the front of the skid loader.

In each of these inventions, the standard scoop bucket normally found on the front of a skid steer loader is removed and replaced with another new device which performs a specialized function. In fact, the standard skid steer loader has been equipped to provide the capability for interchanging various types of front mounted equipment.

However, despite this wide range of equipment, there is a need for a grappling attachment which can be attached to the front of a skid steer loader which is capable of lifting very heavy items and which includes a simplified upper and lower tong activated by a single hydraulic cylinder, and which has a long arm for reaching forward or upward to grasp and relocate these heavy items. While there are a number of inventions which describe variations of grappling attachments for skid steer loaders, none of those inventions fulfill all of these requirements.

For example, U.S. Pat. No. 6,176,531 discloses a grappling attachment having an upper tong and a lower tong. The upper tong is movable through activation of at least one hydraulic cylinder. The lower tong has four forks and is non-movable. The upper tong and lower tong are attached to a backing plate having two attachment points for the hydraulic lifting cylinders which are part of the skid steer loader. However, this invention uses two hydraulic cylinders to generate a grappling action. The grappling action occurs when the two hydraulic cylinders are activated to move the upper tong toward or away from the lower fixed tong. The invention also fails to disclose a long arm and adequate bracing capable of extended reaching.

U.S. Pat. No. 6,098,320 discloses a grappling attachment having a movable upper tong and a non-movable lower tong. In this invention, the grappling action is created through the activation of a single hydraulic cylinder. However, the device does not appear to have any specific attachment points to which the hydraulic cylinders of the skid steer loader may be connected. Also, the two forks of the lower tong are in an essentially vertical position rather than the generally horizontal position of the lower tong of the present invention. And, once again, the device fails to disclose an arm and adequate bracing for extended reach.

Similarly, the device in U.S. Pat. No. 5,564,885 includes a grappling attachment having a movable upper tong and a fixed lower tong. Both tongs are attached to a scoop which are also part of that invention. The grappling action is created through activation of two vertically mounted hydraulic cylinders which move the upper tong toward or away from the fixed lower tong. The device also includes a special adapter mounting plate which must be used to interconnect the grappling device to the skid steer loader. There are no structural elements which can be identified as an arm and adequate bracing for extended reaching.

Finally, U.S. Pat. No. 6,267,547 also discloses a grappling attachment for a skid steer loader. The grappling attachment includes a movable upper tong having three interconnected forks and a lower fixed tong having about seven interconnected forks. The grappling action is generated through the activation of a single hydraulic cylinder which moves the upper tong toward or away from the fixed lower tong. However, once again, the device fails to disclose an arm with sufficient bracing to provide an extended reach.

Thus, despite these various types of grappling attachment for skid steer loader, there is no grappling device which provides a heavy duty grappling tong activated by a single hydraulic cylinder which also includes an arm structure to provide an extended reach for the grappling device.

### SUMMARY OF THE INVENTION

The present invention overcomes these and other problems by providing a grappling attachment with just these types of characteristics. In fact, the present invention resides in a grappling attachment for a skid steer loader which incorporates heavy duty grasping tongs which are actuated by a single hydraulic cylinder mounted to the top of an arm having sufficient bracing to make the grappling attachment capable of providing an extended reach for the grappling tongs.

The present invention also resides in the various embodiments of the above invention. Other objects and features of the present invention will be in part apparent and in part pointed out hereinafter.

### DESCRIPTION OF THE DRAWINGS

FIG. 1 is front view of the grappling attachment as it is installed onto the front of a common skid steer loader.

FIG. 2 is a side view of the grappling attachment showing the grasping tongs in the closed position.

FIG. 3 is a side view of the grappling attachment showing the grasping tongs in the open position.

FIG. 4 is an isometric view of the grappling attachment showing the grasping tongs in the closed position.

FIG. 5 is an isometric view of the grappling attachment showing the grasping tongs in the closed position.

FIG. 6 is an isometric view of the backing plate of the present invention.

FIG. 7 is a side view of the backing plate of the present invention showing how the grappling attachment is attached to the front apparatus of a skid steer loader.

Corresponding reference characters indicate corresponding parts throughout the several views of the drawings.

### DETAILED DESCRIPTION OF THE INVENTION

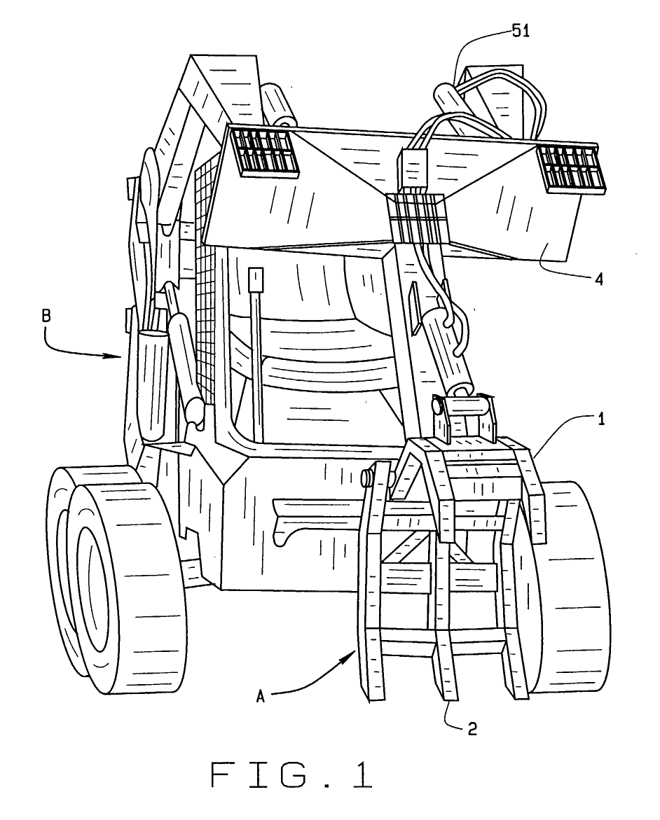

Referring now to the drawings, FIG. 1 shows a grappling attachment A attached to a skid steer loader B. The grappling attachment A has an upper tong 1, a lower tong 2, an arm 3, and a backing plate 4.

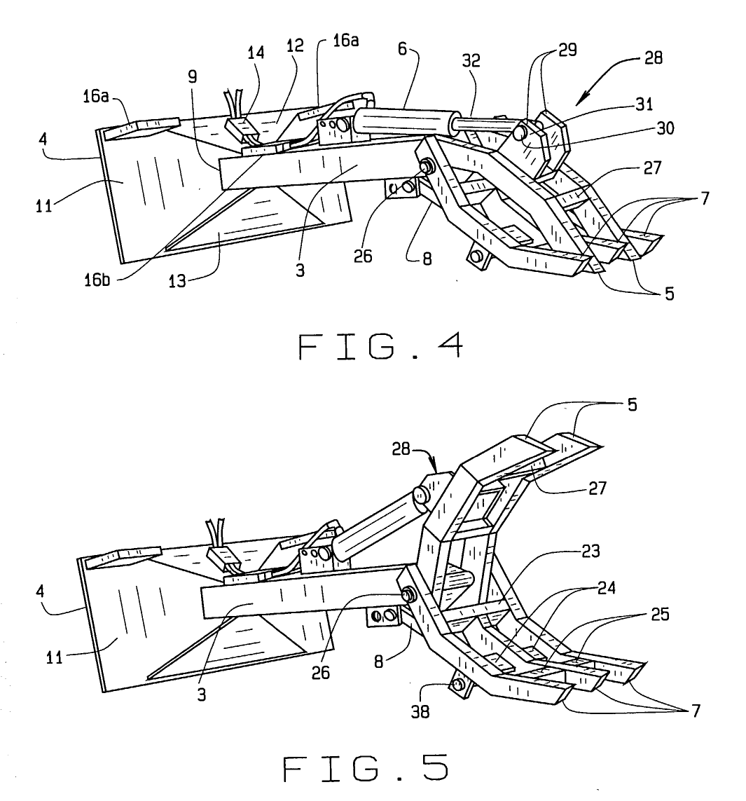

The upper tong 1 includes two upper forks 5 (FIG. 4) and is movable though the actuation of a single hydraulic cylinder 6 mounted to the top of the arm 3. In the embodiment shown, the two upper forks 5 are constructed of metal plates cut and sized such that when welded together they from a generally rectangular shape. Each of the two upper forks 5 consists of three segments 5a, 5b, and 5c (FIG. 3) which are welded together to generate the unique configuration of the upper forks 5 as shown in FIG. 3 and FIG. 5. While the two upper forks 5 in the embodiment shown are a fabrication of welded components, other methods of fabrication can also be used. For instance, rectangular tubes may be cut into the shapes of the three segments 5a, 5b, and 5c, and then welded together. In another embodiment, the two upper forks 5 are constructed of cast iron, while in yet another embodiment, the two upper forks 5 may be constructed of forged steel.

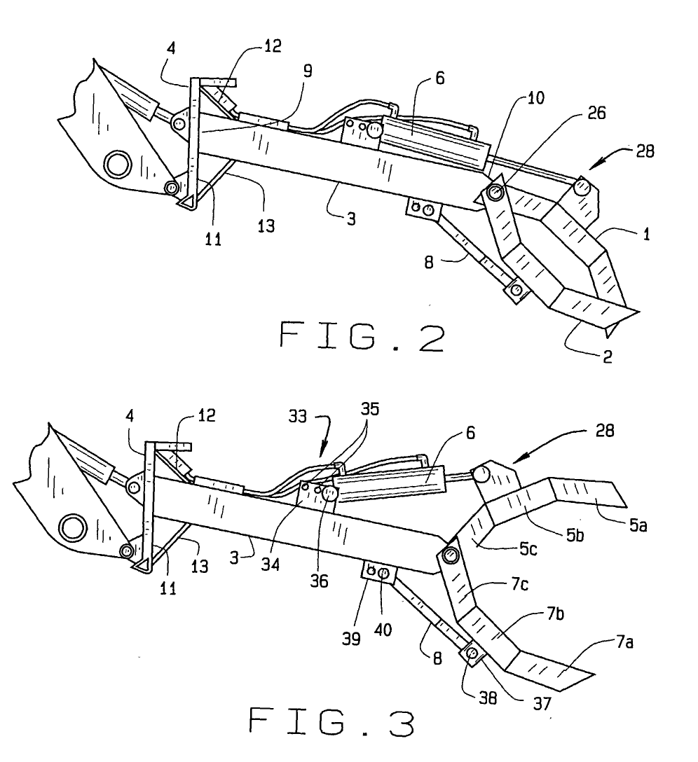

The two upper forks 5 (FIG. 5) are connected together by a transverse brace 27 which is attached to the interior surfaces of each of the two upper forks 5 near the joint of segment 5b and 5c. Additionally, a connection bracket 28 (FIG. 4) is mounted to the top of the two upper forks 5 to provide a connection point for the actuating cylinder 6. The connection bracket 28 has two connection gussets 29, each of which has an opening 31 sized and axially aligned for installation of a connecting point pin 30. The connection bracket 28 is located on the top surfaces of the two upper forks 5 such that when the grasping actuator cylinder 6 is extended to its fully extended position, the tip of the upper fork segment 5a is in an interleaving arrangement with the lower forks 7 of the lower tong 2 as shown in FIG. 2 and FIG. 4. The rod 32 (FIG. 4) of the grasping actuator cylinder 6 is connected to the connection point 28 by aligning the hole in the rod 32 with the openings 31 in the two connection gussets 29 and inserting the connecting point pin 30 into the openings 31 and the hole in the rod 32. The connecting point pin 30 is retained in position by means of fasteners such as hitch pins, cotter pins, or snap rings.

The grasping actuator cylinder 6 (FIG. 3) is also attached to the upper surface of the arm 3 through an attachment point 33. The attachment point 33 includes two attachment point gussets 34 and an attachment pin 36. Each of the two attachment point gussets 34 has three attachment pin opening 35. The end of the grasping cylinder 6 is attached to the two attachment point gussets 34 by aligning the hole in the end of the grasping cylinder 6 with the attachment pin openings 35 and inserting attachment pin 36 through the attachment pin openings 35 and the hole in the end of the grasping cylinder 6. The attachment pin 35 is then retained in position by means of a hitch pin, cotter pin, snap ring or other similar fastener.

The three attachment pin openings 35 allow for alternative attachment points for the end of the grasping cylinder 6. These alternative attachment points provide a means for controlling the position of the upper tong 1 during operation. For example, when the grasping cylinder 6 is attached to the attachment point gussets 34 using the opening 35 which is furthest from the mounting plate 4, the fully open position of the upper tong 1 will be less, and the fully closed position will provide more overlap between the upper tong 1 and the lower tong 2 than when the grasping cylinder is attached to the connection pint gussets 34 using the opening 35 which is closest to the mounting plate 4. The opening 35 which is selected will thus be dependant upon the required articulation of the upper tong 1 as required by the operator of the skid steer B.

The lower tong 2 (FIG. 5) includes three lower forks 7 and is non-movable in relation to the arm 3. Each of the three lower forks 7 consists of three segments 7a, 7b, and 7c which are welded together to form the unique shape of the lower forks 7. The two outside forks 7 are connect by a rear brace 23. Two intermediate braces 24 and two front braces 25 connect each of the three lower forks 7 together. The tips of each of the three forks are angled to create a generally pointed end which allows the lower forks 7 to better slide beneath an object to be picked up by the grappling attachment A.

As in the case of the upper tong 1, the three lower forks 7 of the lower tong 2 in the embodiment shown are a fabrication of welded components, other methods of fabrication can also be used. For instance, rectangular tubes may be cut into the shapes of the 7a, 7b, and 7c segments and then welded together. In another embodiment, the three lower forks 7 are constructed of cast iron, while in yet another embodiment, the three lower forks 7 may be constructed of forged steel.

The lower tong 2 (FIG. 3) is braced against the arm 3 by means of a strut 8 extending between the bottom of the lower tong 2 and the bottom of the arm 3. The strut 8 is attached to the bottom surface of the lower tong 2 by two brackets 37 and a pin 38. The strut 8 is also attached to the underside of the arm 3 by mounting channel 39, the mounting channel 39 having two sets of holes for accepting a connector pin 40. The strut 8 is generally Y-shaped and is installed such that the two upper portions of the Y-shape are attached to the two brackets 37. The position of the lower tong 2 can be adjusted by inserting the connector pin 40 into either the first of second set of holes in the mounting channel 39.

The arm 3 (FIG. 2) is generally tubular and is flat at its distal end 9 and formed to a rounded taper on the proximate end 10. The distal end 9 of the arm 3 is attached to the front face 11 of the backing plate 4 and the arm 3 is braced against the backing plate 4 by an upper gusset 12 and a lower gusset 13 which extend from the top of the arm 3 and the bottom of the arm 3 respectively to be attached to the front face 11 of the backing plate 4. Two upper foot plates 16a are attached to the front of the backing plate 4 and a lower foot plate 16b is attached to the arm 3 to allow the operator to stand on the grappling attachment A.

The upper tong 1 and the lower tong 2 are attached to the proximate end 10 of the arm 3 by a main pivot pin 26. Through holes in the upper tong 1 and the lower tong 2 are sized and located to match a similar through hole in the proximate end 10 of the arm 3. The main pivot pin 26 is retained in the through holes by fasteners such as hitch pins, a cotter pins, or snap rings.

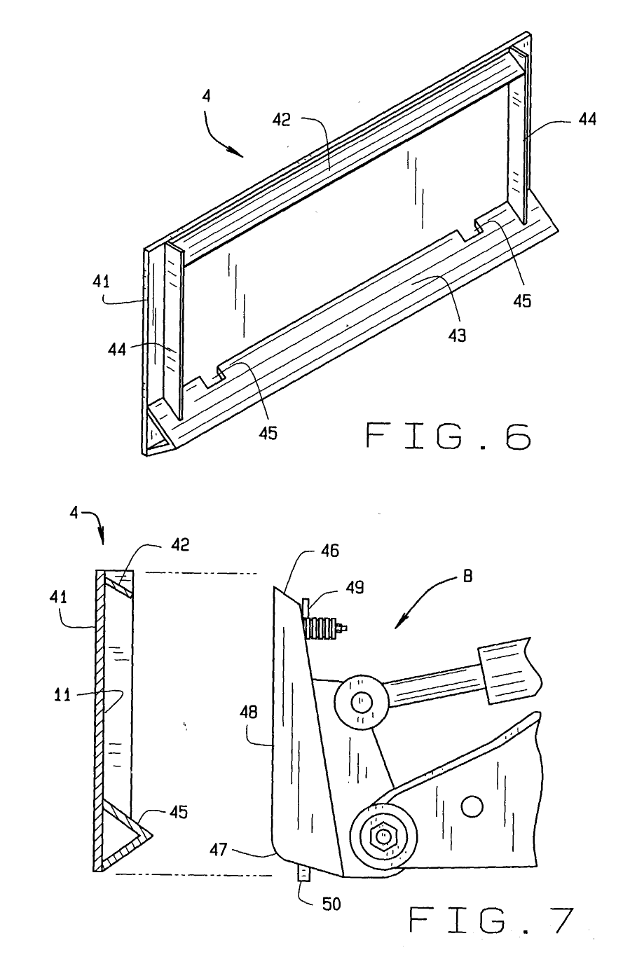

The grappling attachment A is includes a means of attaching the backing plate 4 to the front apparatus of a common skid steer loader B. In the embodiment of the invention disclosed herein, the means of attachment is found on the backing plate 4. The backing plate 4 (FIG. 6) includes a plate 41, an upper mounting strip 42, a lower mounting angle 43, and two vertical strips 44. The lower mounting angle 43 has two slots 45 in its upper surface to accept the locking dogs 50 of the skid steer loader B. Referring to FIG. 7, the backing plate 4 is mounted onto the front apparatus of the skid steer loader B by positioning a first tapered surface 46 underneath the upper mounting strip 42. The front surface 48 of the front apparatus of the skid steer loader is then positioned against the back face 11 of the plate 41. In doing so, a second tapered surface 47 of the skid steer loader B comes to rest upon the top of the lower mounting angle 43. The installation is completed by activation of the two handles 49 of the skid steer loader B to cause the locking dogs 50 to engage into the two slots 45 of the lower mounting angle 43. It is appreciated that while the method of attaching the grappling attachment to the skid steer loader B is described for the current embodiment, the present invention may include other methods of attachment to the skid steer loader B depending upon the design of the front apparatus of the skid steer loader. These other methods of attachment are within the scope of the invention claimed herein.

After the grappling attachment A is attached to the front of the skid steer loader the grasping cylinder 6 is connected to the appropriate auxiliary hydraulic connection 51 (FIG. 1) on the skid steer loader B. The auxiliary hydraulic connection 51 on the skid steer loader B allows the operator to manipulate a control handle corresponding to the auxiliary hydraulic outputs to open and close the tongs on the grappling attachment A. A hose guide 14 (FIG. 4) is attached to the upper gusset 12 to prevent the hydraulic hoses from dangling and being damaged.

While the above description describes various embodiments of the present invention, it will be clear that the present invention may be otherwise easily adapted to fit any configuration where a grappling attachment for a skid steer loader or other type of earth moving vehicle may be utilized.

In view of the above, it will be seen that the several objects of the invention are achieved and other advantageous results attained. As various changes could be made in the above constructions without departing from the scope of the invention, it is intended that all matter contained in the above description or shown in the accompanying drawings shall be interpreted as illustrative and not in a limiting sense.

| | |
|---|---|
| 1. | upper tong |
| 2. | lower tong |
| 3. | arm |
| 4. | backing plate |
| 5. | upper forks |
| 6. | hydraulic cylinder |
| 7. | lower fork |
| 8. | strut |
| 9. | distal end |
| 10. | proximate end |
| 11. | front face |
| 12. | upper gusset |
| 13. | lower gusset |
| 14. | first mounting point |
| 15. | first mounting gusset |
| 16. | lower foot plate |
| 17. | back face |
| 18. | first pivot pin hole |
| 19. | second mounting point |
| 20. | second mounting gusset |
| 21. | second pivot pin hole |
| 22. | second mounting pin |
| 23. | rear brace |
| 24. | intermediate brace |
| 25. | front brace |
| 26. | main pivot pin |
| 27. | transverse brace |
| 28. | connection bracket |
| 29. | connection gusset |
| 30. | connecting point pin |
| 31. | openings |
| 32. | rod |
| 33. | attachment point |
| 34. | attachment point gusset |
| 35. | attachment pin opening |
| 36. | attachment pin |
| 37. | bracket |
| 38. | pin |
| 39. | mounting channel |
| 40. | connector pin |
| 41. | plate |
| 42. | upper mounting strip |
| 43. | lower mounting angle |
| 44. | vertical strip |
| 45. | slot |
| 46. | first tapered surface |
| 47. | second tapered surface |
| 48. | front surface |
| 49. | handle |
| 50. | locking dog |
| 51. | auxiliary hydraulic connection |

What is claimed is:

1. A grapping device for a skid loader, comprising:
a backing plate;
an arm projecting from the backing plate, the arm being at least 4.0 feet in length and being braced by an upper gusset and a lower gusset;
an upper tong attached to a proximate end of the arm;
a lower tong attached to the proximate end of the arm;
means for manipulating the upper tong with the lower tong in a manner which allows the upper tong and the lower tong to coordinate to grasp objects; and
means for attaching the backing plate to a skid steer loader.

2. The grappling attachment of claim 1 wherein the upper tong has two upper forks.

3. The grappling attachment of claim 2 wherein the lower tong has three forks.

4. The grappling attachment of claim 3 wherein the two upper forks of the upper tong interleave with the three lower forks of the lower tong when the upper tong is manipulated with the lower tong in a manner which allows the upper tong and the lower tong to coordinate to grasp objects.

5. The grappling attachment of claim 4 wherein the upper tong has a transverse brace connecting the two upper forks together.

6. The grappling attachment of claim 5 wherein the lower tong has a rear brace connecting the two outer lower forks, an intermediate brace between each of the three lower forks which connects each lower fork to the adjacent lower fork, and a front brace between each of the three lower forks which also connects each lower fork to the adjacent lower fork.

7. The grappling attachment of claim 6 wherein the means for manipulating the upper tong and lower tong in a manner which allows the upper tong and the lower tong to coordinate to grasp objects includes an actuating cylinder capable of moving the upper tong.

8. The grappling attachment of claim 7 further comprising a connection bracket for attaching the actuating cylinder to the upper tong, at least two attachment point gussets for attaching the actuating cylinder to the arm, and an attachment pin to connect the actuating cylinder to the at least two attachment point gussets.

9. The grappling attachment of claim 8 wherein each of the at least two attachment point gussets have at least three openings, the at least two attachment point gussets being positioned such that the at least three openings are axially aligned to allow the attachment pin to connect the actuating cylinder to the at least two attachment point gussets by installing the attachment pin through two of the axially aligned openings and the actuating cylinder.

10. The grappling attachment of claim 9 wherein the arm has a distal end, a proximal end, an upper surface, and a lower surface.

11. The grappling attachment of claim 10 further comprising a strut which connects the lower tong to the bottom surface of the arm.

12. The grappling attachment of claim 11 wherein the at least two attachment points are positioned on the upper surface of the arm.

13. The grappling attachment of claim 12 wherein the arm is flat at its distal end and is rounded at its proximate end.

14. The grappling attachment of claim 13 wherein the means for attaching the backing plate to a skid steer loader comprises a plate, the plate having an upper mounting strip, two vertical strips, and a lower mounting angle, the lower mounting angle having two slots which cooperate with a set of locking dogs on a skid steer loader.

15. The grappling attachment of claim 14 further comprising two upper foot plates mounted onto the plate of the backing plate and a lower foot plate mounted to the upper surface of the arm.

16. The grappling attachment of claim 15 further comprising a main pivot pin which connects the upper tong and the lower tong to the proximate end of the arm.

17. The grappling attachment of claim 16 wherein the arm has a generally rectangular shape.

18. The grappling attachment of claim 17 wherein the upper tong, the lower tong, the arm, the backing plate, and the actuating cylinder enable the grappling attachment to lift at least one ton.

19. The grappling attachment of claim 18 wherein the actuating cylinder is hydraulic.
